(19) United States
(12) Patent Application Publication
(10) Pub. No.: US 2025/0242390 A1
(43) Pub. Date: Jul. 31, 2025

(54) PORTABLE ULTRASONIC CLEANING SYSTEM FOR SMALL ITEMS

(71) Applicant: Sebastien Brayshaw, Miami, FL (US)

(72) Inventor: Sebastien Brayshaw, Miami, FL (US)

(21) Appl. No.: 19/037,270

(22) Filed: Jan. 26, 2025

Related U.S. Application Data
(60) Provisional application No. 63/625,415, filed on Jan. 26, 2024.

(51) Int. Cl. B08B 3/12

(52) U.S. Cl. CPC B08B 3/12

(57) ABSTRACT

Delicate, small, items that become soiled by particulates that adhere to their sides are often difficult to clean. Using brushes and abrasive cleaners may damage the items. A system which holds the items immersed in fluid and makes use of agitating the fluid to loosen soiling particulates may clean the items without significant risk of damaging them.

### TECHNICAL FIELD

The invention is a portable system for cleaning small items using ultrasonic sound for water agitation

### BACKGROUND OF INVENTION

Ultrasonic-sound cleaning, using ultrasonic sound to agitate fluid to clean a fluid-immersed item has been available for decades.

Such systems typically are fixed in place and large enough to clean items of basketball size. A variety of fluids may be used wherein the item to be cleaned is immersed in the fluid which, in turn, is contained in a subsystem operative to convey the ultrasonic physical vibrations to the fluid.

The item immersed in the agitated fluid is, in turn, impacted by rapid fluid motion which can loosen soiling particulates adhering to the item to be cleaned.

### BRIEF DESCRIPTION OF INVENTION

The invention herein disclosed and claimed is a portable ultrasonic cleaning system whose size is conducive to cleaning small items, such as dental appliances and jewelry. The invention comprises two subsystems-a vessel and base. The vessel comprises an embedded ultrasonic transducer, and a detachable lid. The base comprises control electronics, and an induction power conveyance subsystem operative to provide power to the vessel's embedded ultrasonic transducer when the vessel subsystem is firmly attached to the top of the base subsystem, and the base subsystem is powered on.

The vessel subsystem, containing a fluid, has an item to be cleaned immersed in the fluid. As the induction conveyed power excites the vessel's embedded transducer, the latter will begin vibrating the vessel and its contained fluid. The agitated fluid will, in turn, help loosen soil particles on the item to be cleaned. After a predetermined amount of time, the power is turned off, and the vessel's fluid may be spilled out after retrieving the item to be cleaned.

The vessel may also be used as a storage container for the now-cleaned item.

### BRIEF DESCRIPTION OF DRAWINGS

FIG. 1 depicts a three-dimensional view of lid, vessel and base.

FIG. 2 depicts the vessel subsystem from a side view.

FIG. 3 depicts the vessel subsystem from a side and bottom-up view.

FIG. 4 depicts a base subsystem.

FIG. 5 is a flow diagram for method-of-use of the invention.

### DETAILED DESCRIPTION OF INVENTION

Delicate, small, items that become soiled by particulates that adhere to their sides are often difficult to clean. Using brushes and abrasive cleaners may damage the items. A system which holds the items immersed in fluid and makes use of agitating the fluid to loosen soiling particulates may clean the items without significant risk of damaging them.

The invention herein disclosed and claimed is portable, ultrasonic-sound-based cleaning system. It is comprised of two subsystems: a vessel subsystem and a base subsystem.

The vessel subsystem is cup shaped and operative to enable an item to be cleaned to be immersed in a fluid contained by the vessel. An ultrasonic-sound transducer is embedded in the bottom portion of the vessel. It is operative to vibrate at an ultrasonic frequency and convey that vibration to the bottom and sides of the vessel.

The base subsystem comprises a support platform for the vessel subsystem, a power supply, power control and induction power conveyance subsystems.

When external electrical power is supplied to the base subsystem, the subsystems within the base provide induction conveyed power to the vessel subsystem once the latter is securely seated on the top portion of the base.

The conveyed power received by the vessel's embedded transducer activates the transducer to vibrate at an ultrasonic-sound frequency with predetermined frequency and intensity. The vibrating transducer will produce sympathetic vibration of the vessel's bottom and sides. A fluid contained within the vessel subsystem will be alternatively pushed and pulled by the vibrating vessel creating, in effect, physical ultrasonic-frequency wave action.

A item immersed in the vessel subsystem's fluid will be agitated by the fluid's wave action for a predetermined period of time. Because of the fluid's liquid and wave properties, an item soiled by adhering particulates will shed the soiling particulates into the fluid.

Once the cleaning action has ended, the particulates will be detached from the item and the item will be clean of them.

The following description of the invention subsystems provide further detail.

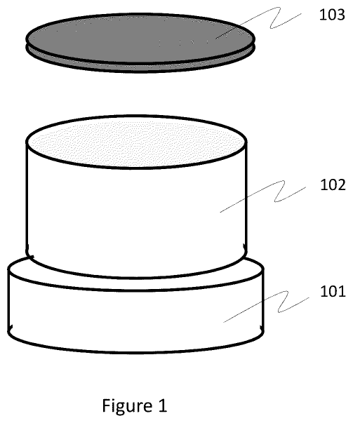

FIG. 1 shows the base (101) and vessel (102) subsystems, and their juxtapositions. The detachable lid (103) can prevent spillage and may be used in conjunction with the detached vessel subsystem to provide a storage means for one or more items that have been cleaned.

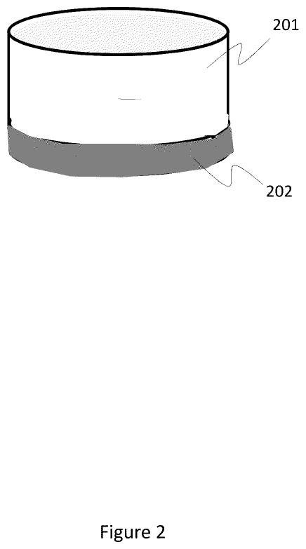

FIG. 2 provides more detail of the vessel subsystem. The upper portion (201) is essentially a cylindrically shaped cup operative to contain a fluid and one or more items to be cleaned. The bottom portion (202) is a non-conducting, rigid, layer in which the ultrasonic-sound transducer is embedded (not shown).

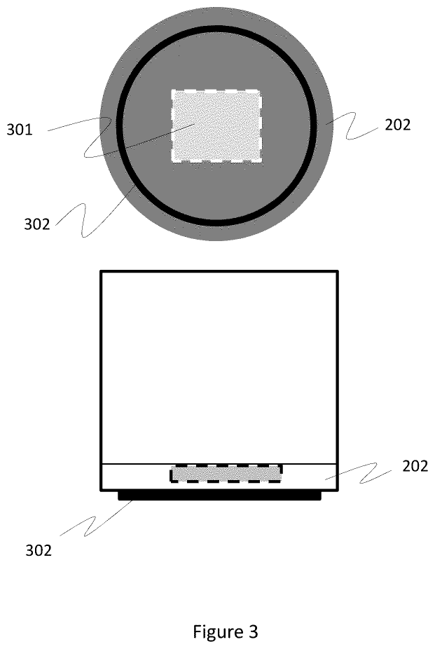

The side view and bottom-up view provided in FIG. 3 shows the embedded ultrasonic-sound transducer (301) firmly embedded in the non-conducting lower-portion of the vessel (202) and a locking ring (302) operative to interface with a complementary locking ring on the top portion of the base to provide a locked, secure, attachment when aligned.

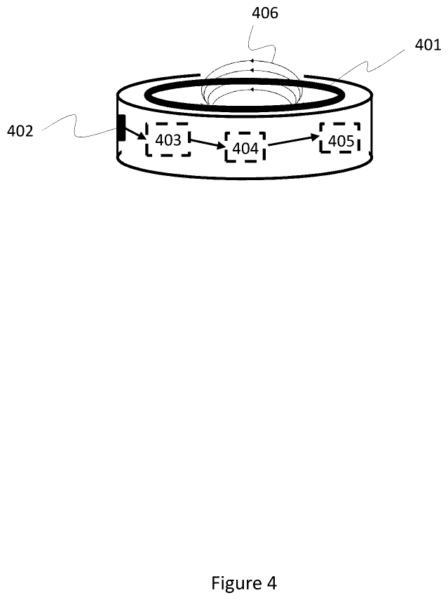

In FIG. 4, the base subsystem has a complementary locking ring (401) to that of the vessel subsystem's. A standard electrical connecting interface (402) is a means of conveying utility power or utility-power-derived voltage to the base subsystem. The power provided is conveyed to a power-supply subsystem (403), which conveys power to a timing, control and power-regulation subsystem (404), and to an induction power conveying subsystem (405) which couples via electro-magnetic induction (406) to the embedded ultrasonic-sound transducer embedded in the vessel subsystem once the vessel subsystem is seated and locked to the upper portion of the base.

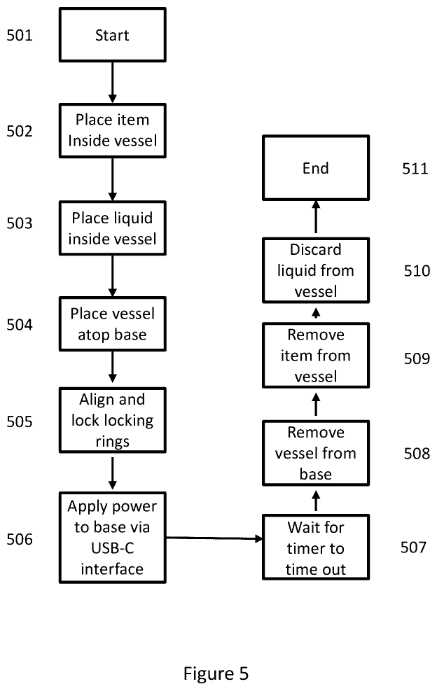

FIG. 5 is a flow chart describing an exemplary method of use for the invention. As shown, the item is placed inside the vessel subsystem (502) after the start (501). Next, the vessel is filled with the fluid to a predetermined level (503). Then the vessel subsystem is seated atop the base subsystem (504). The complementary locking rings on the vessel and base subsystems are then aligned and locked together (505). Power is applied to the base subsystem (506) which causes the induction-conveyed power to be applied to the embedded ultrasonic-sound transducer. Once the cleaning operation times out (507), the vessel subsystem is unlocked and removed from the base subsystem (508), the item is then removed from the vessel subsystem (509), the liquid is discarded from the vessel subsystem along with now detached soiling particulates (510), and the cleaning process ends (511).

The vessel subsystems upper portion is made of metal. The lower portion can be any non-conducting material that will form a solid, rigid layer and support efficient transfer of embedded transducer vibration to the vessel's upper portion.

The base subsystem enclosure is non-conducting plastic or composite. The position of the power supply and power regulating subsystems is non critical. The induction-conveying power subsystem should be placed so as to provide highest efficiency coupling and power conveyance to the embedded transducer in the vessel subsystem when mounted and locked to the base subsystem.

The timing subsystem in the base subsystem is operative to default to a predetermined duration. It may also be programmed to a user-selected time duration.

What is claimed is:

1. An ultrasonic cleaning system comprising:
a vessel portion;
a base portion:
a lid;
the lid is operative to fit tightly to the upper portion of the vessel;
the vessel and base portions are separable;
the vessel portion is essentially cylindrical;
the vessel comprises an upper and lower portion;
the vessel upper portion is made of metal;
the vessel lower portion comprises non-conducting material, an external locking ring, and an embedded ultrasonic vibration transducer;
the base portion comprises a locking ring that is operative to mate with the vessel portion's external locking ring, an internal regulated DC power supply, an electronic timer, and a modular subsystem operative to convert DC power into electromagnetically induced power;
the embedded ultrasonic vibration transducer in the vessel portion is operative to be powered by the electromagnetically induced power.

2. A system as in claim 1 wherein:
the timer located in the base portion is operative to turn off the magnetically induced power at a predetermined time interval.

3. A system as in claim 1 wherein:
the timer located in the base portion is operative to turn off the magnetically induced power at a user-selected time interval.
